(19) United States
(12) Patent Application Publication
(10) Pub. No.: US 2026/0138237 A1
(43) Pub. Date: May 21, 2026

(54) CLAMPING FIXTURE

(71) Applicant: NINGBO HITORHIKE OUTDOOR CO.,LTD., Ningbo (CN)

(72) Inventors: Fasong GUO, Ningbo (CN); Jinhua ZHAO, Ningbo (CN); Haiming GUO, Ningbo (CN)

(73) Assignee: NINGBO HITORHIKE OUTDOOR CO.,LTD., Ningbo (CN)

(21) Appl. No.: 19/218,405

(22) Filed: May 26, 2025

(30) Foreign Application Priority Data
Nov. 15, 2024 (CN) 202422802081.9

(51) Int. Cl. B25B 5/10; A01K 97/10

(52) U.S. Cl. CPC B25B 5/101; A01K 97/10

(57) ABSTRACT

A clamping fixture includes a clamping seat and an adjustment element, where the clamping seat includes a first seat segment, a second seat segment, and a third seat segment; the second seat segment and the third seat segment are located at two ends of the first seat segment, respectively; the second seat segment and the third seat segment are bent relative to the first seat segment; the adjustment element is connected to the third seat segment; the adjustment element includes a clamping head; the clamping head is configured to reciprocate between the second seat segment and the third seat segment; and each of the first seat segment and the second seat segment is provided with a socket for connecting a device. By changing the structure of the clamping fixture, the clamping fixture can be adjustably clamped to a gunwale and have two sockets and mounting positions for mounting the device.

### CROSS REFERENCE TO THE RELATED APPLICATIONS

This application is based upon and claims priority to Chinese Patent Application No. 202422802081.9, filed on Nov. 15, 2024, the entire contents of which are incorporated herein by reference.

### TECHNICAL FIELD

The present disclosure relates to the technical field of fishing gear and in particular to a clamping fixture.

### BACKGROUND

Clamping fixtures are widely used for securing various types of equipment and structural components, particularly workbenches, support frames or platforms with specific surface or edge profiles. Auxiliary accessories are fixedly mounted onto primary structures through the clamping fixtures to ensure operational stability and safety of equipment. The clamping fixtures are widely used in fishing platforms, workbenches, and diverse industrial and outdoor scenarios. They support the mounting of tools, instruments, or support frames for operations in multiple environments. For example, the clamping fixture is clamped to a gunwale, and a fishing rod holder is mounted onto the clamping fixture.

In the prior art, CN216254843U as an example provides a fishing platform accessory clamping fixture, including a fixture body and a telescopic fixing element. The fixture body includes: a first fixing segment, a second fixing segment, and a third fixing segment. The first fixing segment and the third fixing segment are respectively provided at two ends of the second fixing segment. The first fixing segment is bent relative to the second fixing segment. The telescopic fixing element includes a clamping head configured to reciprocate between the first segment and the third fixing segment. During reciprocation, the clamping head moves toward or away from the second fixing segment. The third fixing segment is formed by bending the free end of the second fixing segment, creating a clamping groove at the bending position. The free end of the third fixing segment is provided with a fourth fixing segment, and the fourth fixing segment extends in a direction opposite to the second fixing segment. The first fixing segment, the second fixing segment, the third fixing segment, or the fourth fixing segment is provided with a connection structure. Magnetic or adhesive fixation methods are rarely used in actual fishing applications, and the existing fixation methods are achieved using metallic components. Thus, two sets of bolt holes are provided at a central position of the second fixing segment for fixing external connectors. Alternative structures such as clamping grooves or sliding channels may also be employed.

In the above clamping fixture solution, the clamping fixture must coordinate with fishing platform accessories. In shipboard applications, after the clamping fixture is clamped to a gunwale, a fishing rod holder is mounted onto the clamping fixture. While this enables rapid assembly and operation of fishing platforms, several limitations persist. The connection structure between the clamping fixture and the fishing rod holder is restricted to a single fixing segment, that is, the first fixing segment, the second fixing segment, the third fixing segment, or the fourth fixing segment. Consequently, on one hand, the clamping fixture cannot simultaneously accommodate two tools, instruments, or support frames for mounting. On the other hand, the clamping direction of the clamping fixture is unidirectional. For example, when two sets of bolt holes are provided at the central position of the second fixing segment as the connection structure, the clamping fixture can only be clamped laterally to the gunwale, forcing the fishing rod holder to be connected to the second fixing segment via bolt structures.

### SUMMARY

An objective of the present disclosure is to provide a clamping fixture. By changing the structure of the clamping fixture, the clamping fixture can be adjustably clamped to a gunwale and have two sockets and mounting positions for mounting a device.

An objective of the present disclosure is to provide a clamping fixture including: a clamping seat and an adjustment element, where the clamping seat includes a first seat segment, a second seat segment, and a third seat segment; the second seat segment and the third seat segment are located at two ends of the first seat segment, respectively; the second seat segment and the third seat segment are bent relative to the first seat segment; the adjustment element is connected to the third seat segment; the adjustment element includes a clamping head; the clamping head is configured to reciprocate between the second seat segment and the third seat segment; and each of the first seat segment and the second seat segment is provided with a socket for connecting a device.

In some implementations, the adjustment element further includes an adjustment lead screw and an adjustment knob; the clamping head and the adjustment knob are connected to two ends of the adjustment lead screw, respectively; the third seat segment is provided with a threaded hole matched with the adjustment lead screw; and the adjustment lead screw fits with the threaded hole to threadedly connect the adjustment lead screw to the clamping seat.

In some implementations, the clamping head is connected to the adjustment lead screw via a bolt structure.

In some implementations, the second seat segment is provided with a first clamping surface; the clamping head is provided with a second clamping surface matched with the first clamping surface; the first clamping surface and the second clamping surface are located at two sides of a clamped object, respectively; and the first clamping surface and the second clamping surface are both V-shaped structures with openings opposite to each other.

In some implementations, each of the first clamping surface and the second clamping surface is provided with a V-shaped soft cushion.

In some implementations, each of the first clamping surface and the second clamping surface is provided with a cushion groove; the cushion groove is matched with the V-shaped soft cushion; a cross-section of the V-shaped soft cushion is C-shaped; a cross-section of the cushion groove is also C-shaped; and the V-shaped soft cushion is nested inside the cushion groove.

In some implementations, the V-shaped soft cushion is provided with a cushion anti-slip groove.

In some implementations, a clamping space is formed between the second seat segment and the third seat segment; the first seat segment is provided with a toothed anti-slip structure; and the toothed anti-slip structure is located on a side of the first seat segment away from the clamping space.

In some implementations, each of two sides of the clamping seat is provided with a material-saving groove.

In some implementations, the material-saving groove is internally provided with a plurality of polygonal anti-slip recesses.

According to the technical solution of the present disclosure, the clamping fixture includes a clamping seat and an adjustment element. The clamping seat includes a first seat segment, a second seat segment, and a third seat segment. The second seat segment and the third seat segment are located at two ends of the first seat segment, respectively. The second seat segment and the third seat segment are bent relative to the first seat segment. The adjustment element is connected to the third seat segment. The adjustment element includes a clamping head. The clamping head is configured to reciprocate between the second seat segment and the third seat segment, enabling the clamping fixture to be adjustably clamped to a gunwale. Each of the first seat segment and the second seat segment is provided with a socket for connecting a device, such that the clamping fixture has two sockets and two mounting positions for mounting the device. Thus, the clamping fixture can be used to simultaneously mount two tools, instruments, or support frames. Specifically, the clamping fixture can achieve lateral or vertical clamping. In case of lateral clamping, a fishing rod holder is connected to the first seat segment. In case of vertical clamping, the fishing rod holder is connected to the second seat segment.

### BRIEF DESCRIPTION OF THE DRAWINGS

The aforementioned features, characteristics, and advantages of the present disclosure, along with others, will become more apparent through the description based on the drawings and embodiments. It should be noted that the drawings are provided solely for illustrative purposes and are not drawn to proportional criteria, so they should not be construed as limiting the protection scope of the present disclosure.

FIG. 1 is a perspective view of a clamping fixture according to the present disclosure;

FIG. 2 is a front view of the clamping fixture according to the present disclosure;

FIG. 3 is a perspective view of a clamping seat according to the present disclosure;

FIG. 4 is a structural schematic diagram of a cushion, in a disassembled state, of the clamping fixture according to the present disclosure; and

FIG. 5 is a cross-sectional view along A-A direction shown in the structural schematic diagram of the cushion, in a disassembled state, of the clamping fixture according to the present disclosure.

Reference Numerals: 1. clamping seat; 11. first seat segment; 111. toothed anti-slip structure; 12. second seat segment; 121. first clamping surface; 13. third seat segment; 131. threaded hole; 14. clamping space; 15. material-saving groove; 151. polygonal anti-slip recess; 2. adjustment element; 21. clamping head; 211. second clamping surface; 22. adjustment lead screw; 23. adjustment knob; 3. socket; 4. V-shaped soft cushion; 41. cushion groove; and 42. cushion anti-slip groove.

### DETAILED DESCRIPTION OF THE EMBODIMENTS

The present disclosure is described in further detail below with reference to the specific embodiments and drawings.

The “embodiment” mentioned herein means that a specific feature, structure, or characteristic described in combination with the embodiment may be included in at least one embodiment of the present disclosure. The term in the specification does not necessarily refer to the same embodiment or a mutually exclusive, independent or alternative embodiment. Those skilled in the art should understand that the embodiments described herein may be combined with other embodiments, provided there is no structural conflict.

In the description of the present disclosure, unless otherwise expressly specified and defined, terms such as “mount”, “connect”, and “connected to” should be comprehended in a broad sense. For example, a connection may be a movable connection, a fixed connection, or an integral connection. Those of ordinary skill in the art may understand specific meanings of these terms in the embodiments of the present disclosure based on a specific situation.

In the description, directional or positional terms such as “upper,” “lower,” “left,” “right,” “height,” “length,” and “width” are used solely for the purpose of accurate description of the embodiments and simplified explanation. These terms do not imply that the referenced components or structures must have a specific orientation or be mounted/operated in a specific orientation.

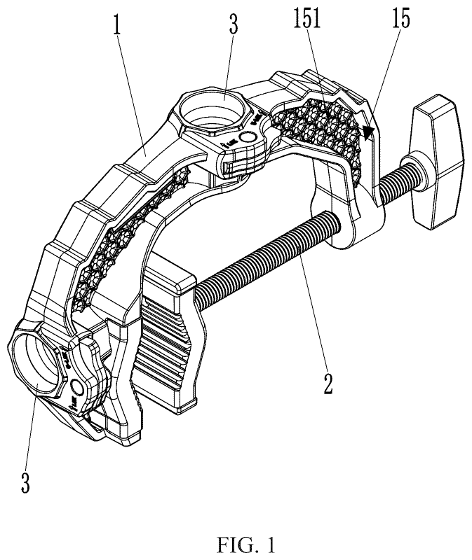

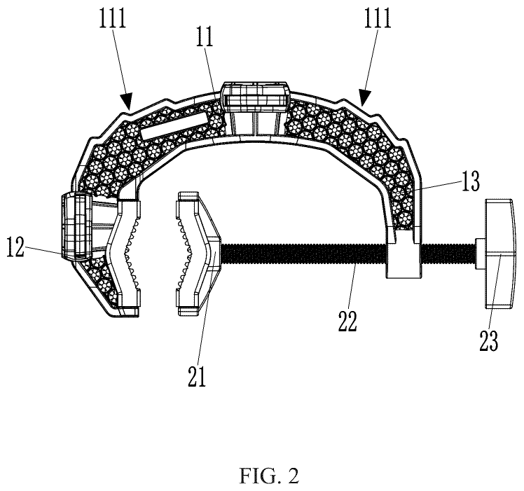

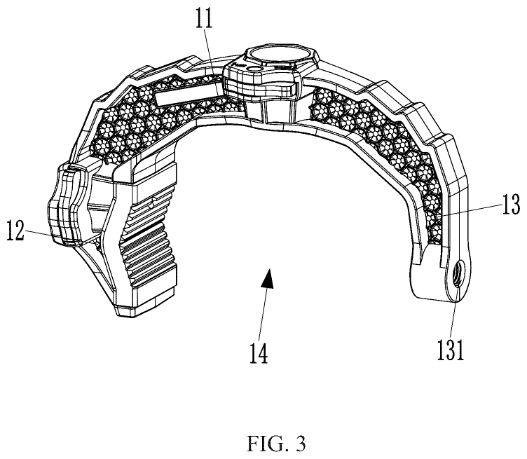

FIGS. 1 to 3 are a perspective view of a clamping fixture of the present disclosure, a front view of the clamping fixture, and a perspective view of clamping seat 1, respectively. The clamping fixture includes the clamping seat 1 and adjustment element 2. The adjustment element 2 is provided on the clamping seat 1. The clamping seat 1 has a “⊏”-shaped structure, and the adjustment element 2 has an ''I''-shaped structure. The clamping seat 1 includes first seat segment 11, second seat segment 12, and third seat segment 13. The second seat segment 12 and the third seat segment 13 are located at two ends of the first seat segment 11, respectively. The second seat segment 12 and the third seat segment 13 are bent relative to the first seat segment 11 and in a same bending direction. The adjustment element 2 is connected to the third seat segment 13. The adjustment element 2 is connected to the clamping seat 1. The adjustment element 2 includes clamping head 21. The clamping head 21 is configured to reciprocate between the second seat segment 12 and the third seat segment 13, enabling the clamping fixture to be clamped a workbench, a support frame, or a platform with a specific surface or edge profile. Furthermore, the adjustment element 2 further includes adjustment lead screw 22 and adjustment knob 23. Specifically, the clamping head 21 and the adjustment knob 23 are connected to two ends of the adjustment lead screw 22, respectively. The clamping head 21 is connected to the adjustment lead screw 22 via a bolt structure. The clamping head 21 is detachably connected to the adjustment lead screw 22. The adjustment lead screw 22 is connected to the adjustment knob 23. Furthermore, the third seat segment 13 is provided with threaded hole 131 matched with the adjustment lead screw 22. The adjustment lead screw 22 fits with the threaded hole 131 to threadedly connect the adjustment lead screw 22 to the clamping seat 1. The mounting and adjustment of the adjustment element 2 are as follows. First, by rotating the adjustment knob 23, the adjustment knob 23 and the adjustment lead screw 22 rotate synchronously, thereby driving the adjustment lead screw 22 to thread into the threaded hole 131. Second, after the adjustment lead screw 22 passes through the threaded hole 131, the clamping head 21 is sleeved on an end of the adjustment lead screw 22, and the clamping head 21 is bolted to the adjustment lead screw 22. Third, the adjustment knob 23 is further rotated to adjust spacing between the clamping head 21 and the second seat segment 12, enabling the clamping fixture to be stably clamped to the workbench, the support frame, or the platform. The advantages of the above solution lie in that the fit between the adjustment lead screw 22 and the threaded hole 131 ensures stable displacement of the clamping head 21 and clamping structure. Furthermore, the detachable connection between the clamping head 21 and the adjustment lead screw 22 allows convenient disassembly and assembly of the adjustment element 2. According to the mounting and adjustment method of the adjustment element 2, a reverse implementation enables disassembly of the adjustment element.

Each of the first seat segment 11 and the second seat segment 12 is provided with a socket 3 for connecting a device. Openings of the two sockets 3 face different directions, such that the clamping fixture includes two sockets 3 and two mounting positions for mounting the device. Thus, the clamping fixture can be used to simultaneously mount two tools, instruments, or support frames. Specifically, the clamping fixture can achieve lateral or vertical clamping. In case of lateral clamping, a fishing rod holder is connected to the first seat segment 11. In case of vertical clamping, the fishing rod holder is connected to the second seat segment 12.

Preferably, in this embodiment, clamping space 14 is formed between the second seat segment 12 and the third seat segment 13. The first seat segment 11 is provided with toothed anti-slip structure 111. The toothed anti-slip structure 111 is located on a side of the first seat segment 11 away from the clamping space 14. The toothed anti-slip structure 111 includes a plurality of tooth-shaped protrusions or grooves provided on the first seat segment 11. The advantage of this solution is that the tooth-shaped protrusions or grooves provide an anti-slip effect when the clamping seat 1 is gripped.

Preferably, in this embodiment, each of two sides of the clamping seat 1 is provided with a material-saving groove 15.

Furthermore, in this embodiment, the material-saving groove 15 is internally provided with a plurality of polygonal anti-slip recesses 151. Specifically, the material-saving groove 15 is internally provided with a plurality of tightly packed hexagonal anti-slip recesses, which are aesthetically pleasing and provide anti-slip effects.

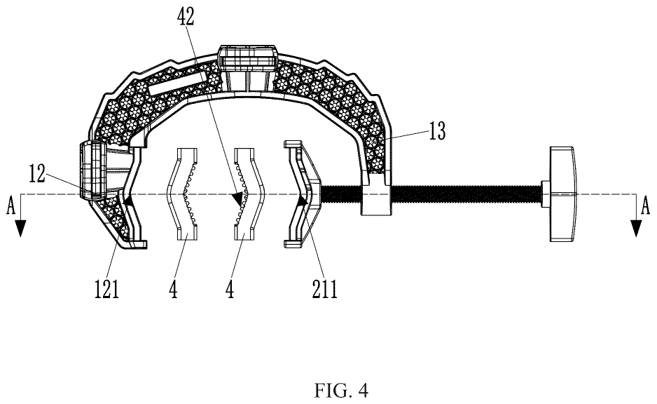

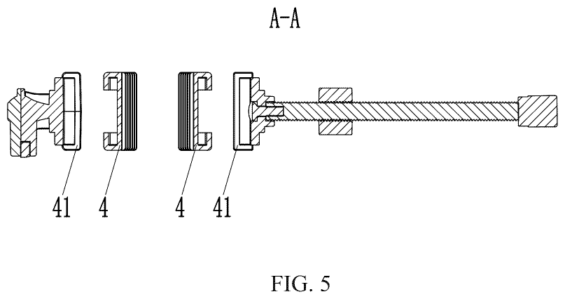

FIGS. 4 and 5 are a structural schematic diagram of a cushion, in a dissembled state, of the clamping fixture of the present disclosure and a cross-sectional view along A-A direction shown in the structural schematic diagram of the cushion, in a dissembled state, of the clamping fixture of the present disclosure, respectively. The second seat segment 12 is provided with first clamping surface 121. The clamping head 21 is provided with second clamping surface 211 matched with the first clamping surface 121. On a boat platform, the clamping fixture is clamped to a gunwale, and the gunwale is located between the first clamping surface 121 and the second clamping surface 211. The first clamping surface 121 and the second clamping surface 211 are located at two sides of a clamped object, respectively. The first clamping surface 121 and the second clamping surface 211 are both V-shaped structures with openings opposite to each other. Furthermore, each of the first clamping surface 121 and the second clamping surface 211 is provided with a V-shaped soft cushion 4. The V-shaped structures of the first clamping surface 121 and the second clamping surface 211 are matched the V-shaped soft cushion 4. The advantages of this solution are as follows. On one hand, the soft cushions protect the clamped gunwale from scratches caused by the clamping fixture. On the other hand, the V-shaped clamping surface is matched with the V-shaped soft cushion 4 to ensure stable clamping of the clamping fixture.

Preferably, in this embodiment, each of the first clamping surface 121 and the second clamping surface 211 is provided with a cushion groove 41. The cushion groove 41 is matched with the V-shaped soft cushion 4. A cross-section of the V-shaped soft cushion 4 is C-shaped. A cross-section of the cushion groove 41 is also C-shaped. The V-shaped soft cushion 4 is nested inside the cushion groove 41. The mounting and removal of the V-shaped soft cushions 4 are convenient, facilitating maintenance and replacement.

Preferably, in this embodiment, the V-shaped soft cushion 4 is provided with cushion anti-slip groove 42. The cushion anti-slip groove 42 includes a plurality of horizontally arranged grooves with triangular cross-sections, increasing deformation space during compression of the V-shaped soft cushion 4.

The purpose of the above embodiments is to provide a detailed explanation of the present disclosure in conjunction with the drawings, thereby enabling those skilled in the art to comprehend the technical concept of the present disclosure. Within the scope of the claims of the present disclosure, optimizations or equivalent substitutions of component structures, as well as the combination of implementations from different embodiments should fall within the protection scope of the present disclosure, provided no conflict arises in structure or principle.

1. A clamping fixture, comprising:
a clamping seat and an adjustment element;
wherein, the clamping seat comprises a first seat segment, a second seat segment, and a third seat segment;
the second seat segment and the third seat segment are located at two ends of the first seat segment, respectively; and the second seat segment and the third seat segment are bent relative to the first seat segment;
the adjustment element is connected to the third seat segment; and the adjustment element comprises a clamping head;
the clamping head is configured to reciprocate between the second seat segment and the third seat segment; and
each of the first seat segment and the second seat segment is provided with a socket for connecting a device.

2. The clamping fixture according to claim 1, wherein
the adjustment element further comprises an adjustment lead screw and an adjustment knob;
the clamping head and the adjustment knob are connected to two ends of the adjustment lead screw, respectively; and
the third seat segment is provided with a threaded hole matched with the adjustment lead screw; and the adjustment lead screw fits with the threaded hole to threadedly connect the adjustment lead screw to the clamping seat.

3. The clamping fixture according to claim 2, wherein
the clamping head is connected to the adjustment lead screw via a bolt structure.

4. The clamping fixture according to claim 1, wherein
the second seat segment is provided with a first clamping surface;
the clamping head is provided with a second clamping surface matched with the first clamping surface;
the first clamping surface and the second clamping surface are located at two sides of a clamped object, respectively; and
the first clamping surface and the second clamping surface are V-shaped structures with openings opposite to each other.

5. The clamping fixture according to claim 4, wherein
each of the first clamping surface and the second clamping surface is provided with a V-shaped soft cushion.

6. The clamping fixture according to claim 5, wherein
each of the first clamping surface and the second clamping surface is provided with a cushion groove; and
the cushion groove is matched with the V-shaped soft cushion; a cross-section of the V-shaped soft cushion is C-shaped; a cross-section of the cushion groove is also C-shaped; and the V-shaped soft cushion is nested inside the cushion groove.

7. The clamping fixture according to claim 5, wherein
the V-shaped soft cushion is provided with a cushion anti-slip groove.

8. The clamping fixture according to claim 1, wherein
a clamping space is formed between the second seat segment and the third seat segment;
the first seat segment is provided with a toothed anti-slip structure; and
the toothed anti-slip structure is located on a side of the first seat segment, wherein the side of the first seat segment is away from the clamping space.

9. The clamping fixture according to claim 1, wherein
each of two sides of the clamping seat is provided with a material-saving groove.

10. The clamping fixture according to claim 9, wherein
the material-saving groove is internally provided with a plurality of polygonal anti-slip recesses.
